(19) United States
(12) Patent Application Publication
(10) Pub. No.: US 2007/0073533 A1
(43) Pub. Date: Mar. 29, 2007

(54) Systems and methods for structural indexing of natural language text

(75) Inventors: Giovanni L. Thione, San Francisco, CA (US); Martin H. Van Den Berg, Palo Alto, CA (US)

Correspondence Address: SUGHRUE MION, PLLC, 401 Castro Street, Ste 220, Mountain View, CA, 94041-2007, US

(73) Assignee: FUJI XEROX Co., LTD.

(21) Appl. No.: 11/405,385

(22) Filed: Apr. 17, 2006

Related U.S. Application Data
(60) Provisional application No. 60/719,817, filed on Sep. 23, 2005.

(51) Int. Cl. G06F 17/27

(52) U.S. Cl. 704/9

(57) ABSTRACT

A structural natural language index is created by segmenting documents within a repository into text portions and extracting named entity, co-reference, lexical entries, structural-semantic relationships, speaker attribution and meronymic derived features. A constituent structure is determined that contains the constituent elements and ordering information sufficient to reconstruct the text portion. A functional structure of the text portions is determined. A set of characterizing predicative triples are formed from the functional structure by applying linearization transfer rules. The constituent structure, the characterizing predicative triples and the derived features are combined to form a canonical form of the text portion. Each canonical form is added to the structural natural language index. A retrieved question is classified to determine question type and a corresponding canonical form for the question is generated. The entries in the structural natural language index are searched for entries matching the canonical form of the question and relevant to the question type. The characterizing predicative triples are used in conjunction with a generation grammar to create an answer. If the generation fails, some or all of the constituent structure of the matching entry is returned as the answer.

This application claims the benefit of Provisional Patent Application No. 60,719,817 filed Sep. 23, 2005, the disclosure of which is incorporated herein by reference, in its entirety.

### BACKGROUND OF THE INVENTION

1. Field of Invention

This invention relates to information retrieval.

2. Description of Related Art

Conventional indexing systems typically function by counting the presence and recurrence of words in text documents. Other conventional indexing systems compute and index loose semantic correlations between concepts. Most commonly, information is extracted from large document collections by selecting documents that contain a set of keywords. In some cases, term proximity relationships are enforced at query time either using precise phrase searches or with fuzzy methods such as sliding windows. These conventional approaches may satisfy some users' needs. However, they fail to extract precise information that satisfies more complex and semantically motivated constraints on the relationships obtaining among concepts, entities and/or events.

### SUMMARY OF THE INVENTION

The systems and methods for efficient structural indexing of natural language text convert natural language statements into a canonized form based on syntactic structure, pronoun tracking, named entity discovery and lexical semantics. The systems and methods according to this invention robustly deal with lexical and grammatical variations at various levels and account for the multiple expressions of high level concepts descriptions linguistically expressed in texts. The pre-indexing provides query processing efficiencies comparable to pure term-based retrieval systems. The retrieval of documents and passages for information extraction and/or answering natural language questions is improved by indexing the documents for higher-order structural information. Texts in a corpus are split into text portions. The syntactic information, named entities, co-reference information and speech attribution of the fragments are determined and syntactically and semantically interconnected information flattened into a linear form for efficient indexing. A canonical form is determined based on constituent structure of the text portion, the flattened syntactic-semantic interconnected information and the derived features obtained by extracting named entity, co-reference, lexical entry, semantic-structural relationships, attribution and meronymic information. The systems and methods according to this invention can handle lexical and grammatical variations between questions and answer phrases. Lexical resources on the semantic and thematic structure of de-verbal nouns are mined and cross-indexed within the corpus in order to account for variations which depart from the syntactic structure of the question or query.

### BRIEF DESCRIPTION OF THE FIGURES

FIG. 1 is an overview of an exemplary structural natural language indexing system according to one aspect of this invention;

FIG. 2 is a flowchart of an exemplary method for structural natural language indexing of texts according to this invention;

FIG. 3 is an exemplary structural natural language indexing system according to one aspect of this invention;

FIG. 4 is a flowchart of an exemplary method searching a structural index according to one aspect of this invention;

FIG. 5 is an overview of the creation of a structural natural language index according to this invention;

FIG. 6 is an exemplary structural natural language index storage structure according to one aspect of this invention;

FIG. 7 is an overview of structural natural language index creation according to one aspect of this invention;

FIG. 8 shows exemplary question-type classifications based on the information extracted from the linguistic analysis of the question according to one aspect of this invention; and

FIG. 9 shows how the matching process differs for different types of questions.

### DETAILED DESCRIPTION OF EXEMPLARY EMBODIMENTS

Systems and methods for efficient structural natural language indexing of natural language text are described. The systems and methods efficiently create structural natural language indices of natural language texts in a grammatically and lexically robust fashion, able to perform well despite many types of grammatical and lexical variation in how similar concepts are expressed. Since variability is permitted, correct answers can be identified despite significant syntactic and lexical variation between the question and the answer.

In one exemplary embodiment according to this invention, the text is fragmented into analyzable portions, analyzed and annotated with a variety of syntactic, lexical and co-referential information. The richly structured data is then flattened and efficiently indexed. Thus systems and methods are provided to transform texts through linguistic analysis into a canonized form which can be efficiently indexed and queried with existing token-based indexing engines. By dealing robustly with lexical and grammatical variations at various levels, the systems and methods according to this invention account for multiple ways in which high-level relationships among concepts can be expressed linguistically in texts. In information retrieval and question answering embodiments according to this invention, the question is transformed into a query compatible with the canonical intermediate representation. The query efficiently returns a restricted and highly correlated set of fragments which are likely to contain the desired information. A re-ranking and matching process then selects the n-best candidates and/or extracts the answer to the user's question.

Most of the computational requirements are offloaded onto the indexing process. In various exemplary embodiments, the indexing process is conducted off-line and is therefore more easily scaled and parallelized making the approach uniquely appropriate for mid-to-large-size collections of confidential and legal or business documents where document indexing is feasible and preferred and where efficiency in retrieval is strongly valued over fast indexing. The systems and methods according to our invention return answers quickly because of the computational frontloading.

Natural Language Question Answering has received wide attention in the recent past, driven on one hand by the needs and requirements of the analyst and intelligence community, and on the other by the increased commercial importance of text search in making information stored in digitized text archives useful to computer users.

Question answer systems are typically composed of: a document indexing component, a question analysis component, a querying component and an answer re-ranking/extraction component.

The systems and methods of this invention facilitate the retrieval of documents in response to questions. The systems and methods according to this invention permit answering questions with a significant amount of lexical and grammatical variation between question and answer phrases. The systems and methods of this invention provide for tracking named entities, and resolving anaphoric links and attributions of quoted material. The higher-order structural information of documents are analyzed. In various exemplary embodiments, the analysis of the documents is done when texts in the corpus are split into portions such as sentences. Each portion is analyzed for derived features such as syntactic information, named entities, co-reference information and speech attribution information. The derived inter-connected syntactic and semantic features are then linearized for efficient indexing.

In one exemplary embodiment, the systems and methods according to this invention are implemented on top of the Fuji-Xerox Active Document Archive (ADA) document management system developed at FX Palo Alto Laboratory Inc. The architecture of the Active Document Archive allows documents to be enriched by dynamic annotation services so that annotations about a document grow over time. This incrementally enriched set of annotations or meta-information is available for distribution to other services or to users as it becomes available. In one exemplary embodiment, the data-analysis and preprocessing of a PALQuest Question Answering System as well as the structural natural language indexing systems and methods are implemented as Active Document Archive services.

The Active Document Archive uses a model of gracefully enhanced performance in the extraction of information from large document archives over time. If a document has been part of the archive for long enough to allow for significant amounts of pre-processing to have been done, more sophisticated retrieval approaches involving named entity extraction, reference resolution etc, may be used; otherwise the retrieval process falls back on simpler standard retrieval techniques involving term-based indexing and querying for recently added documents. Thus, the same query submitted initially to the PALQuest system will return results comparable to existing standard conventional question and answer information retrieval based systems. Increasingly better retrieval results are achieved as more documents are analyzed and indexed with richer annotations.

The Active Document Archive architecture thus permits creation of a robust, evolving document collection that adapts to the addition of new analysis and querying services. The Active Document Archive architecture is particularly suited for deployment in large corporations or government agencies where large amounts of non-publicly available documents are maintained. Documents in these high value conventional archives typically do not support the linking structure based on use that underpin systems such as Google. Therefore, users needing to access information from documents in collections of this sort do not reap the benefits of currently available search systems because of their private and non-connected nature. Users of these conventional archives need robust methods which do not depend on the type of inter-dependence between the content of documents and the popularity of the document to rank candidate answers to queries as found in Google and other conventional information retrieval systems. The method of indexing based on natural language processing techniques covered by the systems and methods according to this invention is an important advance over Google-type retrieval for these high value document collections.

The structural natural language indexing process is structured as follows: initially, documents in a corpus are preprocessed to extract the different types of information used in building the index. At a first stage, segmentation is applied to identify sentential boundaries using a sentence boundary detector, such as the FXPAL Sentence Boundary Detector (FXSBD). Sentence boundary detection is further described in Polanyi et al, “A Rule Based Approach to Discourse Parsing”, Proceedings of the 5^{th} SIGDIAL Workshop in Discourse and Dialogue, Cambridge, Mass. USA pp. 108-117, May 1, 2004.

It should be apparent that although the FXSBD is used is one of the exemplary embodiments, maximal entropy statistical segmentation and other segmentation systems may also be used to segment texts without departing from the scope of this invention.

Subsequently, each fragment or sentence is parsed by an efficient deep symbolic parser such as the deep symbolic parser of the Xerox Linguistic Environment (XLE). The deep symbolic parser of the XLE provides an efficient implementation of a large coverage Lexical functional grammar of English which annotates each sentence with predicate-argument information making available information about which entity in a clause is the subject, which are objects etc. It will be apparent that since multiple parallel grammars for the XLE are under development in a variety of different languages and because most of the components that make up PALQuest operate in a language independent fashion, the systems and methods of this invention may be easily extended to other languages such as Japanese.

Finally, an Entity Extraction component analyzes the texts and annotates them with additional information about named entities (people, places and organizations), time-phrases (date-times and time durations), job titles, and organization affiliations. Because each analytic component runs within the Active Document Archive architecture, the results of the indexing process are a richly annotated set of texts with cross-referential information that allows efficient retrieval of all entity or syntactic information that has been added to a text position in one document. This feature of the processed data enables the retrieval process to rely on rich linguistic information about candidate sentences or passages without loss in responsiveness.

The test corpus we assembled to test the system consisted of 50 full-length articles extracted from the Fuji-Xerox internal circulation corporate magazine “CrossPoint”. During the preprocessing phase each document was segmented into text portions, such as sentences, using a sentence boundary detector. After the documents were segmented, each portion was parsed using the deep symbolic parser of the XLE. For each portion the most probable parse is selected and associated the text portions and three types of structures.

A functional-structure containing deep syntactic information about the chosen parse. The functional structure includes predicate-argument structure information, temporal and aspectual data and some semantic information. For example, semantic information about the quotative adjunct phrases and distinctions between the locational, directional and temporal adjuncts.

A constituent tree structure that preserves the inflectional information and order of the original sentence tokens. The constituent tree is used in generating an answer if generation using the surface string generation components of the generating grammar is un-successful.

A set of predicate triple relations of the form “feature(argument, argument)” generated and stored in association with the sentence. For example, if the sentence is “John walks”, one triple might be SUBJ(walk, John). These triples are derived by the transfer component of a linguistic processing environment such as the XLE. He triples are generated by applying linearization rules to a parse generated by the linguistic processing environment. For example, arguments that refer to the same entities in the original f-structure of an exemplary XLE implementation are marked with identifiers to reflect co-indexing. The triples form a fingerprint or characterization of the parse that is stored in an index storage structure. The triples do not contain all the information that the XLE returns, but are enough to characterize the parsed sentence as one of a small set of similar sentences.

In various other exemplary embodiments according to this invention, the first n-best parses are used. The structural information from the n-best parses is then condensed, normalized and stored within the structural natural language index storage memory. A non-null intersection between the information contained in analyzed text portions and an analyzed question indicates that a match exists and can be returned.

In one exemplary embodiment, linearization rules select the features: SUBJ, OBJ, OBJ-THETA, OBL, ADJUNCT, POSS, COMP, and XCOMP to be included in the triple representation. Additional derived features that do not directly occur in the f-structure are incorporated into the index storage structure to track part of speech (POS) information during WordNet lookups.

The optional named entity extraction process uses a number of different strategies to extract and tag as much relevant information as possible. In various exemplary embodiments, the optional named entity information is used to identify candidate referents for pronouns. The extracted named entity information used to identify possible answers to questions.

In one exemplary embodiment, a set of named entities (of class PERSON, ORGANIZATION and LOCATION) are extracted and identified along with co-reference information. The returned co-reference information resolves third-person singular personal pronouns (he, she) to a previously identified named entity of class PERSON. The other relevant named entities are also identified and annotated.

Using a linguistic structure such as an XLE-generated f-structure for each portion of text, all subordinate clauses introduced by “since”, “when”, “until”, “till”, “before” and “after” are marked as possible Date/Time type of named entities. Temporal prepositional phrases containing tokens identified by XLE with the feature TIME (as in “at three o'clock”) and tokens that contain temporal unit nouns (day, month, hour, etc.) modified by ordinal numbers are extracted.

Phrases containing temporal unit nouns modified by cardinal numbers are considered durations, as well as expressions of the form “from+[to, until]” such as “from 9:00 to 9:30 am”

The structures returned by parsers typically include some named entity information for certain tokens recognized as locations. In one exemplary embodiment according to this invention, utilizing the XLE, directional and locational prepositional phrases are marked such through the PSEM feature and tagged as additional LOCATION entities.

Expressions attributing professional affiliations to an individual such as “Dr. Jim Baker, Chief Executive Officer, FXPAL” are identified. Simply stated, when from the previous named-entity tagging pass, a parenthetical phrase between a PERSON entity and an ORGANIZATION entity is identified, the ORGANIZATION is tagged as the EMPLOYER, and the parenthetical phrase is tagged as the JOB-TITLE.

In constructing the structural natural language index according to one aspect of this invention, each sentence is indexed separately and includes relevant information in a number of different fields. The multiple-fields of the index allow specialized queries to be performed on each field independently. The contents field contains stem forms of all the words in the sentence. In addition, a field is created for each derived grammatical feature (GF) having a corresponding triple derived from the text portion. For example, the field contains a series of pairs of tokens T1 and T2 based on predicates p1 and p2, such that there is a corresponding triple GF(p1,p2).

Each token consists of: 1) the literal predicate as it occurs in the triple; 2) its antecedent, if the predicate is a pronoun, and the antecedent is known (The co-references for he or she are annotated and for third-person plural pronouns and other grammatically salient constituents are also added to the index); 3) the WordNet synset(s) of the literal predicate and its antecedent associated with a lesser weight; 4) the hypernyms of all the synsets of the literal predicate recursively, until the top of the taxonomy, each associated with a progressively reduced weight; 5) the first-level hyponym synset(s) of the literal predicate, associated with weight equal to that of first-level hypernyms.

If “SUBJ(pass,girl)” is stored, a hit will occur for search of “SUBJ(give,child)” because, in at least one meaning, “give” is synonymous with “pass”, and “child” is a hypernym of “girl”. This is done because of evidence that episodically people use first-level hyponyms as synonym to a given word. This may also derive from the too fine granularity sometimes employed in discerning among lexical items on different branches of the WordNet taxonomy. In one exemplary embodiment according to this invention, the structural natural language index storage structure indices are generated by the Lucene token-based indexing engine. Each triple is indexed as a two-complex-token string in which each token includes all items (1) through (5) indexed in the same position to encompass non-synonyms.

In addition to the grammatical feature fields of the derived features, named entity tracking and co-reference tracking information are also indexed in a series of additional derived feature fields. Named entities are stored in a first set of separate fields (company, person, date-time, location, duration, employer, job-title) in which the verbatim named entity phrases are indexed along with pointers to the sub-f-structure indices. It will be apparent that other linguistic notations and processing environments such as Discourse Structure Theory, or the like, may also be used without departing from the scope of this invention. The indices can be used to generate answers for querying the generation component and to match sub-parts of the constituent structure.

Finally the case of quotation and reported speech is treated separately. For each sentence parsed, we track uses of communication verbs, such as “say”, and index the agent entity such as the syntactic subject, or its referent when identified, as the speaker entity. The clausal object is then indexed as usual, extracting it from the quoted context. By heuristically monitoring the deployment of quotation marks, sequences of quoted sentences are attributed to the same speaker. For each sentence identified as reported speech, the speaker entity is stored in a speaker field. In addition, each occurrence of the first-person pronoun is resolved to the speaker in the quoted material, whether the information about the speaker is encoded in nominative, accusative or possessive form.

In addition to these fields, the term vector for the complete document is associated with each text portion. This allows the index to account for differences in salience between similar sentences with respect to the impact of words in the query while preserving speed and storage efficiency. In one exemplary embodiment, a pointer to the term vector is stored and associated with each text portion instead of the complete text. The result of a lookup in the index storage structure is therefore a ranked set of candidate answer-sentences.

In another exemplary embodiment, the term frequency vector is substituted with a Latent Semantic Indexing vector corresponding to the words in a document (the dual of the term vector after SVD (Single Value Decomposition) has been applied to the entire collection.) This allows for better semantic similarity detection between a sentence (question) and a document from which a possible answer candidate was chosen.

In answering questions the systems and methods for structural natural language indexing, a question is first parsed using a parser such the parser of the XLE. As with the sentences from the corpus documents, a set of relevant triples is derived from the parse result. Named entity information and information from the question type such as “when” implying time, how long implying a duration, who implying a person. This derived information, combined with the words in the question, is used to retrieve best matches from a database such as Lucene. The result of a query is a list of sentences ordered by: (1) how well they match the words and predicative structure of the question; and 2) certain named entities as required by the detected type of the question. This set of possible candidates tends to be significantly smaller than one returned simply by seeking occurrence of words, thus capturing part of the question-answer matching process in the retrieval phase.

The corresponding full parse which had been previously stored and linked to the index is examined for every sentence located in the order in which the results are returned. The parse structure of the candidate sentence is matched with the parse-structure of the question to determine if the wh-target is identifiable in the candidate answer. If it is, the corresponding sub-f-structure, is extracted and the generation component of the XLE is called to generate the corresponding answer. If the generation fails, original words in the constituent (c-) structure of the XLE-parse of the text portion corresponding to the matching f-structure are extracted and returned.

Question-types are classified according to the information extracted from the linguistic analysis of the question. The different type of questions are associated with the evidence used to assign the specified category, and the constraints applied on query generation by having identified that specific type of question. In addition, if the question target is within an embedded quoted context, the question is marked accordingly (e.g. When did X say the final decision was made?) and the speaker field will also be required in the query. For substantive questions about some person's reported speech (what did X say about Y) the query is further constrained with respect to the subject being reported.

Once a question has been parsed, a query is generated according to its type and characteristics. A typical query is composed of a series of conjoined or disjoined clauses, each specifying a field and a term or phrase that should be found in the index. These clauses capture the syntactic and predicative characteristics sought for. For example, a question such as “Where did FX hold its 2005 investor meeting?” would yield the following simplified query. If a text portion generates entities in the index associated with time or location, and the index entities information is derived from named entity extraction, the entity information is associated with the value “_FILLED”. The value is stored within the index to efficiently indicate the availability of this type of temporal or locational information.

FX hold 2005 investor meet
+OBJ:”hold meeting”
+SUBJ:”hold FX”
POSS:”FX meeting”
+location:_FILLED

Although the query incorporates many of the syntactic and predicative constraints that each possible answer should satisfy, the structural natural language index facilitates the retrieval of a very small set of candidate results with very high speed because of its linear token-basis, allowing a great deal of lexical variability between the questions and answers.

In the case of the example above, the pronoun “its” is resolved to its antecedent “FX”. The resolved pronoun is then substituted into the query for the triple POSS(FX,it). It is important to notice that transforming both the candidate answers (in indexing them) and the question to this intermediate predicative representation, already accounts for a significant amount of syntactic variation, such as passivization and cleft-constructions, which leave the argument structure locally unmodified. Certain constructions in the question that unnecessarily complicate its structure, such as it-clefts are also normalized. Questions such as “What is it that John bought from Luke” are canonized to the same form that “What did John buy from Luke” would yield, and so on. The constraints OBL, and POSS are relaxed since their presence in the question is not necessarily maintained in all satisfactory answers. For example the sentence

In 2005, FX held the annual investor meeting in Fukuoka.

clearly answers the question and the possessive attribution is understood. Notice that the POSS clause in the query above is not a mandatory clause. This ensures that good answers are not missed while boosting the rank of those sentences that more closely match the original structure. The lexically flexibility of the indexing system also accounts for an additional level of variation and would match the following sentences as candidate answers:
FX had its annual investor meeting at Fukuoka.
FujiXerox's 2005 investor meeting was held at Fukuoka
It was at Fukuoka, the corporate retreat, that FX held its 2005 annual investor meeting
In 2005, Fuji-Xerox held its annual investor gathering at the corporate retreat, in Gotemba, Japan.

In addition, including all stemmed content words in the query interacts both with the contents field for each text portion and with the term-vector stored with the text portions, relating them to the original document to which they belonged. This boosts words more closely resembling the question in clausal or prepositional adjuncts and which are not part of the currently indexed argument-structure. It also boosts the salience of text portions that come from documents “more similar” to the question, in the traditional IR sense.

In attempting to extract the answer to a question from a candidate answer sentence, the syntactic structure of the question is compared to that of the candidate. The comparison process analyzes the syntactic dependency chain from the root verb predicate of the main clause to the interrogative pronoun (wh-word). First, the structure of the question (normalized in dependency triples) is analyzed to identify the grammatical function of the wh-word. In the example “What did John buy?” the wh-word functions as the direct object of the verb buy. Then the f-structure of the candidate is traversed until a predicate corresponding to the verb governing the wh-word is encountered or all possible links have been traversed. At each step in the traversal, the grammatical information from the question is then enforced to be consistent with that in the candidate. Consistency is satisfied when: 1) the morpho-syntactic triples are identical; 2) the morpho-syntactic triples are equivalent with respect to synonymic, hypernymic and meronymic lexical relations; or 3) the morpho-syntactic triples are equivalent, according to a set of encoded equivalency rules such as for it-cleft constructions.

The traversal through each structure is performed until either: 1) a hit, indicated by a syntactic constituent is found in the candidate answer, which plays the same grammatical role in the candidate answer as the wh-word did in the question; or 2) no hit, indicated by no correspondence determined during the matching process. If no hit is indicated, the candidate is discarded for the next one.

In the case of a successful hit, the internal index for the identified constituent is extracted from the f-structure and used to generate a syntactically well-formed answer using a two-layered strategy. First the XLE generation component running the parsing grammar “backwards” is queried to generate a surface form from the sub f-structure identified as the correct answer. A well-formed constituent phrase is generated from the parsed text portion. In the few cases in which this process fails, or a well-formed sub f-structure corresponding to the answer can not be determined, the identifier for the answer is used to determine a location within the c-structure of the candidate answer. A sub-portion of the original sentence corresponding to the determined location is extracted as the answer. This may be necessary when the original parse was a fragmentary parse. In various other exemplary embodiments, the complete text portion is returned as an answer when the system fails to determine a specific sub constituent corresponding to the answer.

For questions that constrain the category of the answer such as “WHERE”, “WHO”, “HOW_LONG”, and “WHEN”, information from the named entity tagging phase and/or the annotated candidate answer is used to constrain the set of candidate answers to those for which the category of the extracted sub constituent matches the one requested by the question type. In these cases, once a successful match is determined between the grammatical structures of a question and candidate answer, the candidate answer is searched for named entities of the classes required by the specific question type. These are stored in the additional named-entity related fields for the index storage structure record associated with the candidate along with index information that points to the grammatical named entity information within the f-structure of the text portion. For example:
John sold his Jaguar to Mark in early December 1994.

During named-entity tagging, “December 1994 is recognized” as a time phrase and the phrase is indexed in the DATETIME field, along with an identifier pointing to the closest embedding adjunct or complement phrase “in early December 1994” would be stored in the index. In processing the question, “When was John's car sold?”, the following query is generated:
+POSS(John, car)+OBJ(sell, car)+DATETIME:_filled

This query matches the correct answer thanks to the lexically flexible index and intra-sentential pronoun resolution. The “+DATETIME:_filled” clause requires that the candidate answers being returned show some entity that was recognized as being of type DATETIME. “The “_filled” value is a generic token that is added to the index storage structure whenever some entity is also included in a named-entity field. Thus, a sentence like “John sold his Jaguar to Mark in early December 1994” is returned. The sentence “John sold his car to Mark because he needed money” would not match the “DATETIME:_filled” constraint and would therefore not be selected to match the question. The figure shows how the matching process differs for different types of questions and specifies the lexical and linguistic clues used to approximate answers to more complicated questions such as HOW questions and WHY questions.

In general, the number of candidates returned varies with how many obligatory constraints make up the query. Although, for certain question-types more relaxed queries are permitted. Also, certain types of constraints on the candidate such as meronymic constraints are currently not enforced at query time. A question such as what car did “John buy” requires candidates such “John bought a Jaguar” and “John bought a house” to be evaluated with respect to the relation between jaguar and car (the good one!) and “jaguar” and house (not so good). In such a case a (simplified) query SUBJ:“buy John” would have returned us both. This is solved by candidate re-ranking/evaluation time via WordNet lookups.

While XLE generated triples carry cross-referential indices to link different triples together—These types of constraints are not easily enforced in a simple token-based query as would be possible in an SQL query. So for example the sentence “John bought a new boat after Mary showed him the car she bought” would yield the following after resolving personal and relative pronouns:
SUBJ(buy,John) OBJ(buy, car) SUBJ(show, Mary)
OBL(show, John) OBJ(show,car) SUBJ(buy, Mary) OBJ(buy, car)

One significant limitation of the canonization and indexing process as outlined so far is that, with the exception of the set of grammatical transformations that are accounted for, such passivisation, clefts, etc., the grammatical structure of the question and that of the answer must be predicatively similar. Predicative similarity is defined as follows. When a verb with certain complements is used in a sentence, a predicatively similar sentence will contain a lexical variant of that verb, complemented with lexical variants of the original complements, in grammatically equivalent positions. Nominalized constructions and numerous other naturally occurring variations between semantically equivalent phrases do not respect predicative similarity. Therefore, in order to encompass greater variability between questions and answers, the indexing process is expanded to correctly account for nominalization. Nominalizations are grammatical constructions in which information that would normally be encoded as a verb is, instead, encoded in the form of a noun expressing the action of the verb. Accounting for nominalization in indexing, thus, takes a step in the direction of providing a semantic link between sentences that, while expressing the same eventualities, do so in significantly different syntactic ways.

Consider the following example:
The Red Sox's victory of the World Series in 2005 ended the Curse of the Bambino.
   Without some method of dealing with nominalizations, there is no effective way of matching this sentence to questions that privilege the predicative aspects of the de-verbal noun “victory”, such as in “Who won the World Series in 2005?”. By the same token, while substituting de-verbal nouns with gerunds is licit (e.g. “winning” instead of “victory”) it would still be difficult to answer questions such as, “What did the Red Sox winning the World Series in 2005 cause?” For this reason, noun-based constructions based on de-verbal nouns are analyzed and indexed so that the predicative aspects of the verbs from which they derive are highlighted and made explicit in the index.

In order to do this, two sets of annotated corpus data are cross-referenced. In one embodiment, nominalization lexicons such as the NOMLEX data, annotate nouns with the verb from which they derive, and then possible sub-categorization information for the noun are crossed with that of the verb. For example, from the entry for the noun “promotion” one can observe that the possessive modification of the noun (as in “Jim's promotion”) can either match the subject or the object of the verb “promote”, but the choice between the two is dependent on the presence of an additional prepositional complement introduced by the preposition “of’. Thus, “Jim's promotion to CEO” implies OBJ(promote, Jim) whereas “Jim's promotion of Alan to senior VP” implies SUBJ(promote, Jim) and OBJ(promote, Alan). In some cases there may still be some ambiguity as to the thematic role the complement of a noun phrase fills, in the frame of the related verb. Consider the following sentences:
The steamboat's invention dates back to 1783.
Robert Fulton's invention revolutionized the world.
   It is clear that “steamboat” is the object being invented, while “Robert Fulton” is the inventor. In order to extract such information and correctly structurally index texts that show noun complements whose syntactic role is ambiguous, a cross reference between a nominalization lexicons and sub-categorization data about verbs and nouns which describes complements in terms of their lexical semantic properties is determined. For example, the sub-categorization frame for “invent” shows that the agent must be either a person or an organization whereas the patient need to be an abstract concept or a tangible object. To correctly disambiguate such cases then, properties and features of the complements are recognized by means of named-entity tagging and lexicographic resources, and cross referenced with sub-categorization information from the nominalization lexicon and the sub-categorization data to determine the correct frame and thematic roles for each complement. The text is then structurally indexed in the usual manner to its canonized representation.

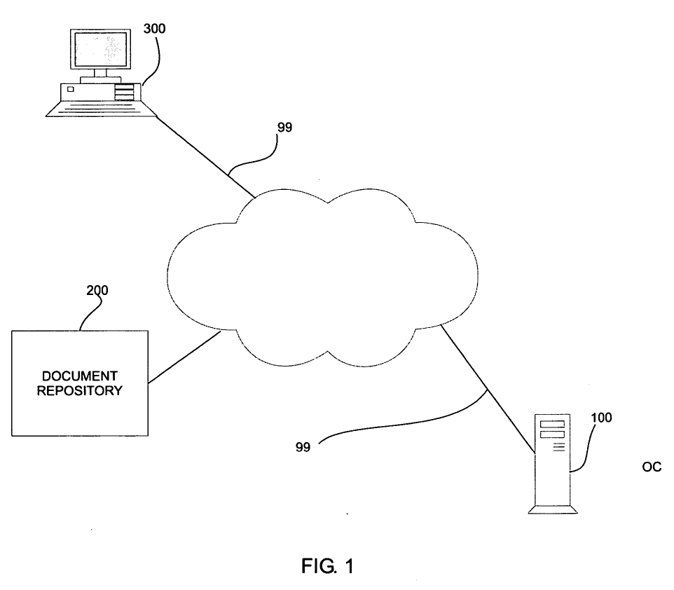

FIG. 1 is an overview of an exemplary structural natural language indexing system according to one aspect of this invention. An communication-enabled personal computer 300 is connected via communications links 99 to a structural index system 100 and to a document repository 200.

The structural natural language indexing system 100 retrieves the documents from the document repository 200. Each document is segmented into text portions. Linguistic analysis is performed to generate a linguistic representation for the text portion. In various exemplary embodiments utilizing the XLE, the linguistic representation is an f-structure.

A set of linearization transfer rules is applied to the linguistic representation to generate a set of relations characteristic of the text portion called an f-structure. A set of transfer rules is then applied to the flattened f-structure to generate a set of derived features. The derived features may include, but are not limited to: named entity, co-references, lexical entities, structural-semantic relationships, speaker attributions and meronymic information identified in the f-structure. A representation of each text portion is associated with the flattened f-structure and the derived features to form a structural index.

A question text is entered by the user on the communications-enabled personal computer 300. The question is forwarded via communications links 99 to the structural natural language index system 100. The question is segmented into question portions. A flattened f-structure and derived features are generated. The query is then classified by question type. The question type, the flattened f-structure and the derived features are used to select candidate answers to the question from a structurally indexed corpus. A grammatical answer is created by generating text from the salient portion of the f-structure associated with a selected candidate answer. If the grammatical answer generation fails, some or all of the constituent structure is returned as the answer. The grammatical answer is then returned to the user of the communications-enabled personal computer 300 over communications links 99.

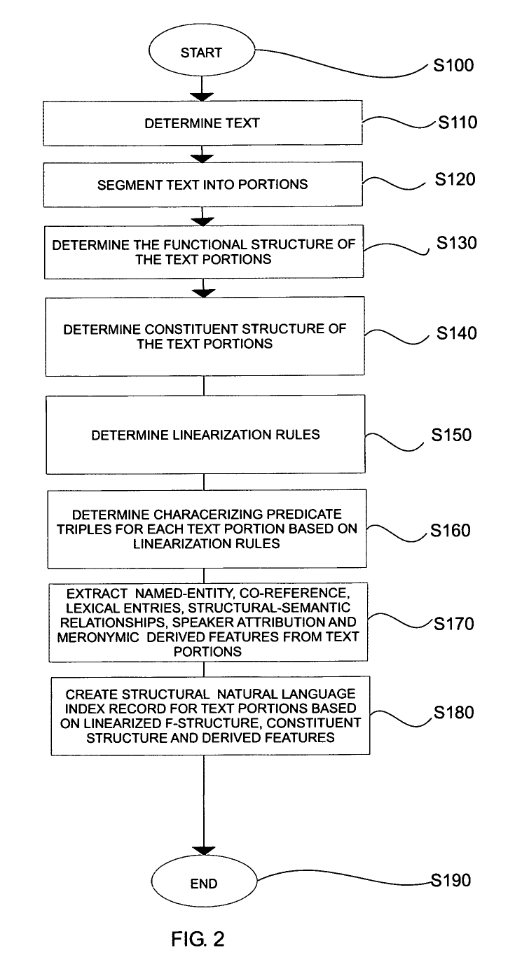

FIG. 2 is a flowchart of an exemplary method for structural natural language indexing of texts according to this invention. The process begins at step S100 and immediately continues to step S100 where a text is determined.

The text is selected from a file system, input from a keyboard or entered using any other known or later developed input method. After the text has been determined, control continues to step S120. The text is segmented into portions in step S120. For example, in one exemplary embodiment according to this invention, the text is segmented into sentences using a sentence boundary detector. After the text has been segmented into portions, control continues to step S130.

In step S130, the functional structure of each text portion is determined. The functional structure is determined using the parser of a linguistic processing environment such as the XLE. The parser of the XLE, parses sentences and encodes the result into a compact functional structure called an f-structure. After the f-structure has been determined, control continues to step S140.

In step S140, the constituent structure of the text portions are determined. The constituent structure contains sufficient constituent and ordering information to reconstruct the text portion. Control then continues to step S150.

In step S150, linearization transfer rules are determined. In one embodiment according to this invention, the linearization rules are XLE transfer rules capable of operating on the f-structure. The linearization transfer rules create flattened representations of functional structures such as the f-structure. After the linearization transfer rules have been determined, control continues to step S150.

In step S160, the linearization transfer rules are applied to the functional structure to create predicate characterizing triples called a flattened f-structure that characterize the text portion. Control then continues to step S170. In step S170, derived feature information such as named entity, co-reference, lexical entries, structural-semantic relationships, speaker attribution and meronymic information is extracted from the text portions. In various embodiments, the derived features are obtained from a parser operating on the text portion.

For example, named entities describe locations, names of individuals or organizations, acronyms, dates or times, time lengths or durations. Co-reference information, includes the set of possible antecedents for any occurrence of an anaphoric pronoun, word, or phrase. Lexical entries are phrases that appear as they are in lexical databases, resources or encyclopedias. Structural-semantic relationship information include specific patterns that express semantic relationships between adjacent, collocated or otherwise structurally related words or phrases, such as the (PERSON, JOB, ORGANIZATION) pattern.

Speaker tracking and quotative attribution information includes the presence of certain words or verbs associated with reported speech and the analysis of punctuation and of genre conventions, the individual or organization to whom a sentence or otherwise defined fragment of language is attributed and similar syntactic structures. Meronymic information includes word senses, hypernyms, and hyponyms determined from lexical resources such as WordNet, providing part of speech information. After the derived feature information has been determined, control continues to step S180. In step S180, the constituent structure, the characterizing triples and the derived features are used to create a canonical record that is associated with the text portion in the structural natural language index structure. After the structural natural language index has been created, control continues to step S190 and the process ends.

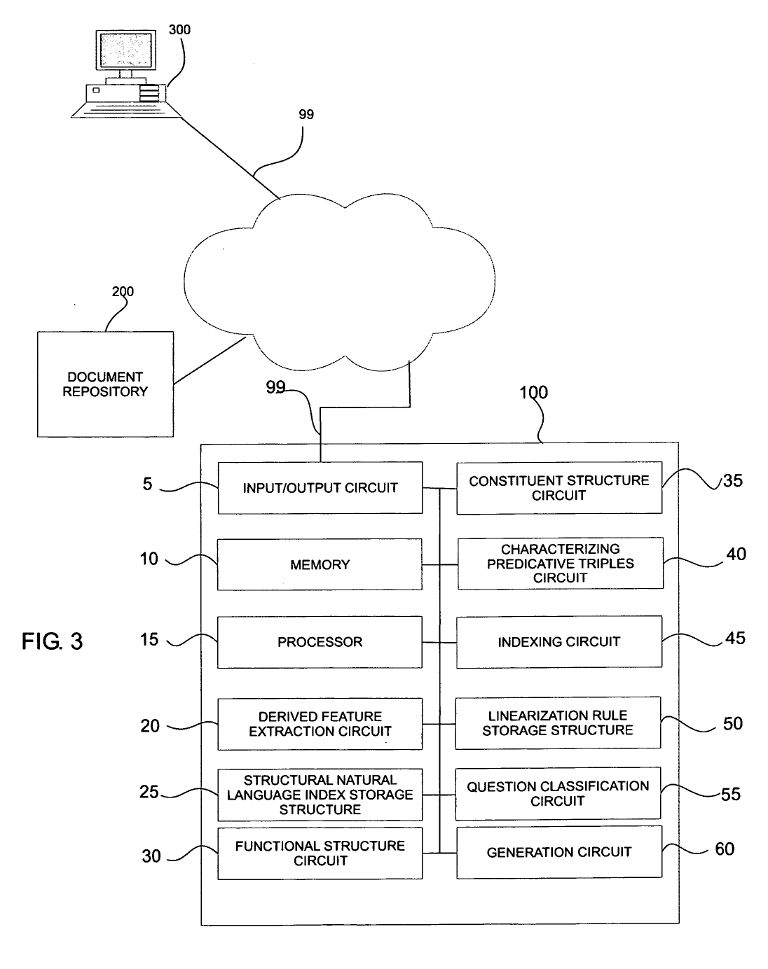

FIG. 3 is an exemplary structural natural language indexing system according to one aspect of this invention. A communication-enabled personal computer 300 is connected via communications links 99 to a structural index system 100 and to a document repository 200.

The processor 15 of the structural natural language indexing system 100 activates the input/output circuit 5 to retrieve a question entered by a user of communications-enabled personal computer 300 over communications link 99. The processor 15 activates the constituent structure circuit 35 to determine a constituent structure for the question. In various exemplary embodiments, the constituent structure circuit 35 is a parser that tokenizes the question and determines an ordering of the tokens sufficient to allow the original question to be reconstructed. The processor 15 then stores the resultant constituent structure into a memory 10.

The derived feature extraction circuit 20 is then activated by the processor 15 to extract named entity, co-reference, lexical entries, structural-semantic relationships speaker attribution and meronymic feature information from the question. The derived features are stored in the memory 10.

The processor 15 then activates the functional structure circuit 30 to determine a functional structure of the question. For example, in various embodiments, the XLE parser is used to generate a f-structure type of functional structure for the question. The f-structure efficiently encodes various readings of the question into a single representation. The processor 15 then activates the characterizing predicative triples circuit 40. The characterizing predictive triples circuit 40 retrieves a set of linearization transfer rules from the linearization transfer rule storage structure 50. The linearization transfer rules are applied to the previously determined functional structure. The linearization transfer rules resolve pronouns and other antecedents in the functional structure and select a set of triples that characterize the question.

The processor 15 retrieves the constituent structure and the derived features from memory 10, combines them with the characterizing predicative triples and stores the result canonical question in the memory 10. The type of question is determined by activating the question type classification circuit 55. The processor 15 then activates the index circuit 45 to create a canonical question based on the canonical form stored in memory 10 and the question type.

The processor 15 selects canonical entries from the structural natural language index storage structure 25 that match the canonical question and the question type. The processor 15 activates the generation circuit 60 to generate an answer based on the matching canonical entries. In one exemplary embodiment, the answer is generated by applying a generation grammar to the characterizing predicative triples of the matching entry. If the answer generation fails, some or all of the constituent structure associated with the matching entry is returned as the answer.

It will be apparent that the previously stored structural natural language index is generated by segmenting corpus documents into text portions. Corresponding canonical forms of the text portions are determined by applying the circuits as described. The resultant canonical forms and associated text forms are then entered into structural natural language index and saved within the structural natural language storage structure 25.

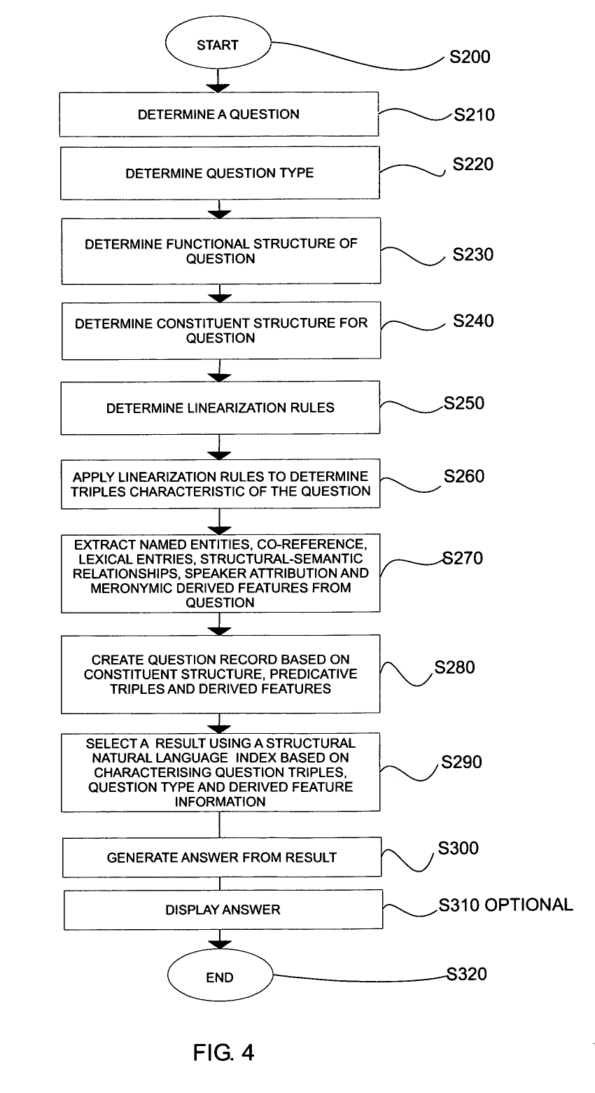

FIG. 4 is a flowchart of an exemplary method searching a structural index according to one aspect of this invention. The process begins at step S200 and immediately continues to step S210. In step S210, a natural language question is determined. The question may be determined based on input from the keyboard, a speech recognition system, optical character recognition, highlighting a portion of text and/or using any other known or later developed input or selection method. After the question has been determined, control continues to step S220.

In step S220, the type of question is determined and additional features are derived. Control then continues to step S230. In step S230, the functional structure of the question is determined. In one exemplary embodiment, the XLE environment is used to create an f-structure type of functional structure. The f-structure provides a compact encoding of the possible meanings represented by the question. After the function structure of the question has been determined, control continues to step S240.

In step S240, a constituent structure for the question is determined. In various exemplary embodiments, the constituent structure is determined by parsing the question using the parser of the linguistic processing environment. Control then continues to step S250.

The linearization transfer rules are determined in step S250. The linearization transfer rules create flattened representations of functional structures such as the f-structure. After the linearization transfer rules have been determined, control continues to step S250.

In step S260, the linearization transfer rules are applied to the functional structure to create predicate characterizing triples called a flattened f-structure that characterizes the question. Control then continues to step S270. In step S270, derived feature information such as named entity, co-reference, lexical entries, structural-semantic relationships, speaker attribution and meronymic information is extracted from the question. In various embodiments, the derived features are obtained from a parser operating on the question.

After the derived feature information has been determined, control continues to step S280. In step S280, the constituent structure, the characterizing triples and the derived features are used to create a canonical question record that is associated with the question. Control then continues to step S290.

In step S290, the structural natural language index is selected. The structural natural language index is a previously created structural language index associated with a document repository to be queried. A result is selected from the structural natural language index based on the characterizing predicative triples, the question type and the derived features. Control then continues to step S300.

In step S300, an answer is generated from the selected result. In various exemplary embodiments, the answer is generated by applying a generation grammar to a portion of the functional structure associated with the result. If the process fails, then all or part of the constituent structure associated with the result is returned. After the answer has been generated, control continues to optional step S310 where the answer is displayed to the user. Control then continues to step S320 and the process ends.

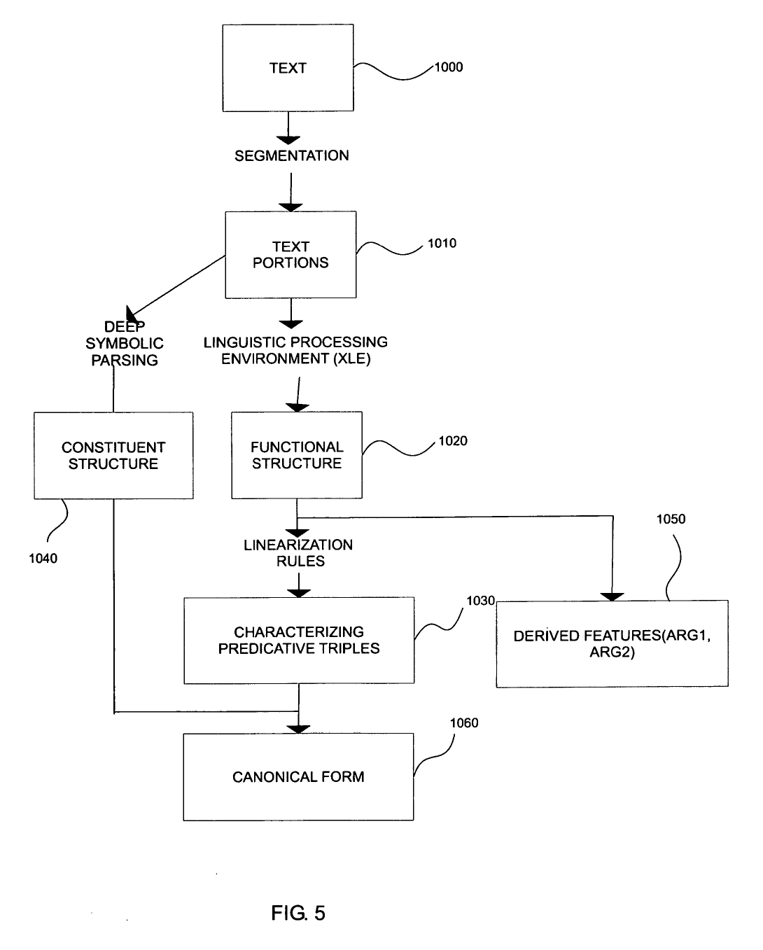

FIG. 5 is an overview of the creation of a structural natural language index according to this invention. A text 1000 is segmented into text portions 1010. Deep symbolic processing, parsing and/or other methods are used to create a constituent structure 1040. The constituent structure include the elements of the text portions as well as sufficient ordering information to allow for the reconstruction of the original text portion.

The text portion 1010 is also processed by a linguistic processing system, such as the parser of the XLE. The resultant functional structure 1020 reflects the semantic meaning of the sentence. A set of linearization transfer rules is then applied to the functional structure 1020. The linearization transfer rules flatten the hierarchical functional structure into predicative triples from which a set of characterizing predicative triples 1030 are selected. Derived features 1050 are determined based on named entity extraction, lexical entries, structural-semantic relationships, speaker attribution and/or other meronymic information. A canonical form 1060 is then determined based on the constituent structure 1040, the characterizing predicative triples 1030 and the derived features 1050.

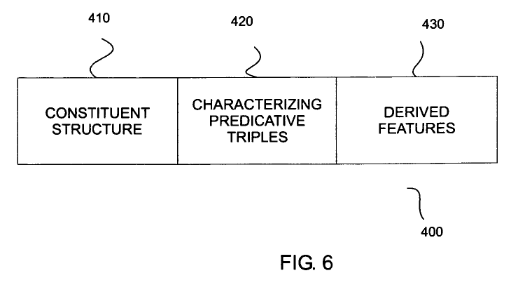

FIG. 6 is an exemplary structural natural language index storage structure 400 according to one aspect of this invention. The exemplary structural natural language index storage structure 400 is comprised of a constituent structure portion 410; a characterizing predictive triples portion 420; and a derived features portion 430.

The constituent structure portion 410 contains the constituent elements of the original text or question portion coupled with ordering information. The constituents and the ordering information are used to reconstruct the original or source text or question portion. In various exemplary embodiments according to this invention, the constituent and ordering information is obtained from a deep symbolic parse of the text portion. However, it will be apparent that various other methods of obtaining the constituent structure information may be used without departing from the scope of this invention.

The characterizing predicative triples portion 420 contains flattened functional or f-structure information obtained by applying a set of linearization transfer rules to the functional structure or f-structure created by the parser. The functional structure is a hierarchical structure encoding a large quantity of information. The hierarchical structure of the functional structure represents the large number of generations possible from ambiguous sentences.

The linearization rules are applied to the f-structure to determine a set of triples that characterize the information content of the f-structure. The characterizing predicative triples are stored in the characterizing predicative triples portion 310.

The derived features portion 430 is comprised of features obtained by the application of transfer rules for extracting features based on: named entity, co-references, lexical entities, structural-semantic relationships, speaker attributions and meronymic information. These derived features are stored in the derived feature portion of the index storage structure 400. The exemplary structural natural language index storage structure 400 provides a representation of the information contained in the functional structure that is efficiently stored and indexed.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

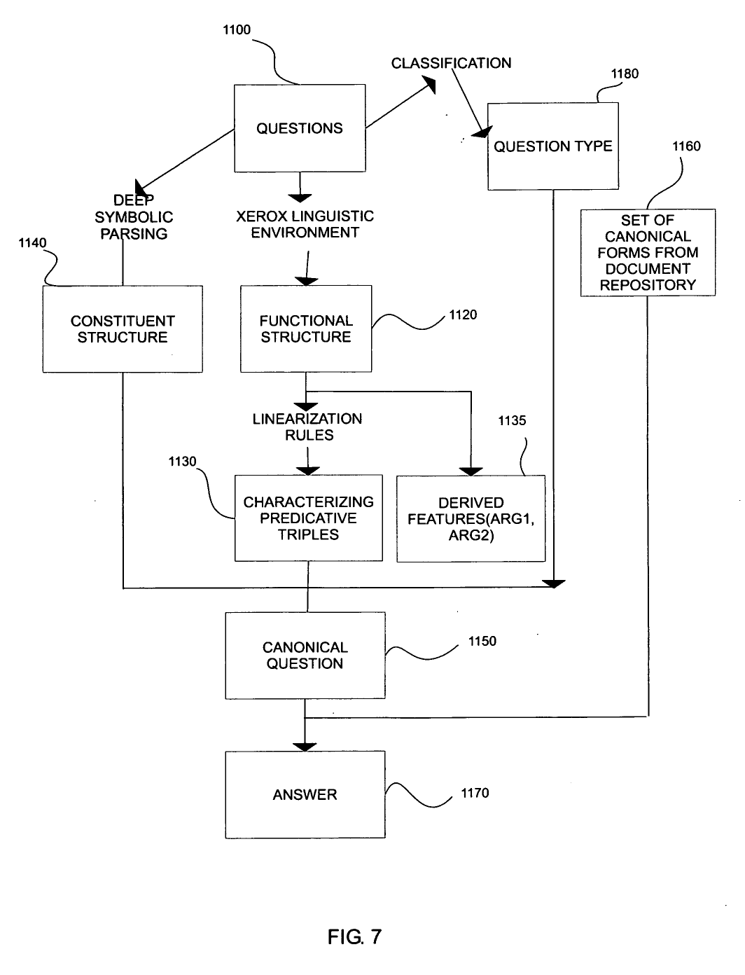

FIG. 7 is an overview of structural natural language index creation according to one aspect of this invention. Deep symbolic processing and/or parsing is used to create a constituent structure 1140 from the question 1100. The constituent structure includes the elements of the question as well as sufficient ordering information to allow for the reconstruction of the original question.

The question 1100 is also processed by a linguistic processing system, such as the parser of the XLE. The resultant functional structure 1120 reflects the semantic meaning of the question. A set of linearization transfer rules is then applied to the functional structure 1120. The linearization transfer rules flatten the hierarchical functional structure into predicative triples from which characterizing predicative triples 1130 are selected. Derived features 1135 are determined from the functional structure 1120 based on named entity extraction, lexical entries, structural-semantic relationships, speaker attribution and/or other meronymic information. The question 1100 is classified and a question type 1180 determined. A canonical question 1150 is then determined based on the constituent structure 1140, the characterizing predicative triples 1130, the derived features 1135 and the question type 1180.

The canonical question 1150 is applied to a previously determined set of canonical forms associated with a document repository. The canonical forms matching the canonical question 1150 are used to generate an answer 1170. In one exemplary embodiment according to this invention, a generation grammar is applied to the matching canonical form. In still other embodiments, question type constraints are applied the set of candidate answer sentences generated. If the generation process fails to yield an answer, all or portions of the constituent structure of the matching canonical form are returned as the answer 1170.

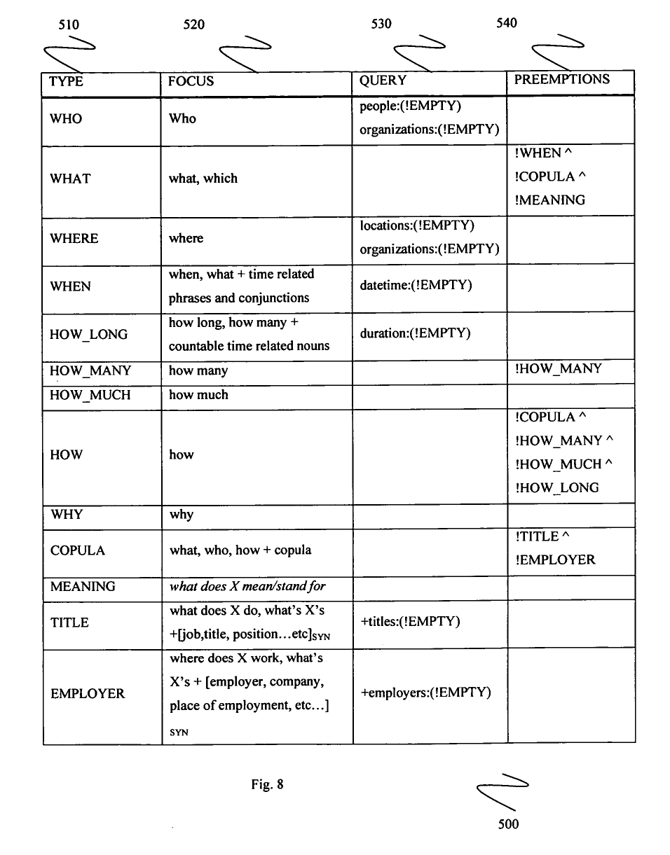

FIG. 8 shows exemplary question-type classifications based on the information extracted from the linguistic analysis of the question according to one aspect of this invention. The different questions types are associated with the evidence used to assign the specified category, and the constraints applied on query generation by having identified that specific type of question. If the question target is within an embedded quoted context, the question is marked accordingly (e.g. When did X say the final decision was made?) and the speaker field will also be required in the query. For substantive questions about some person's reported speech (what did X say about Y) the query is further constrained with respect to the subject being reported.

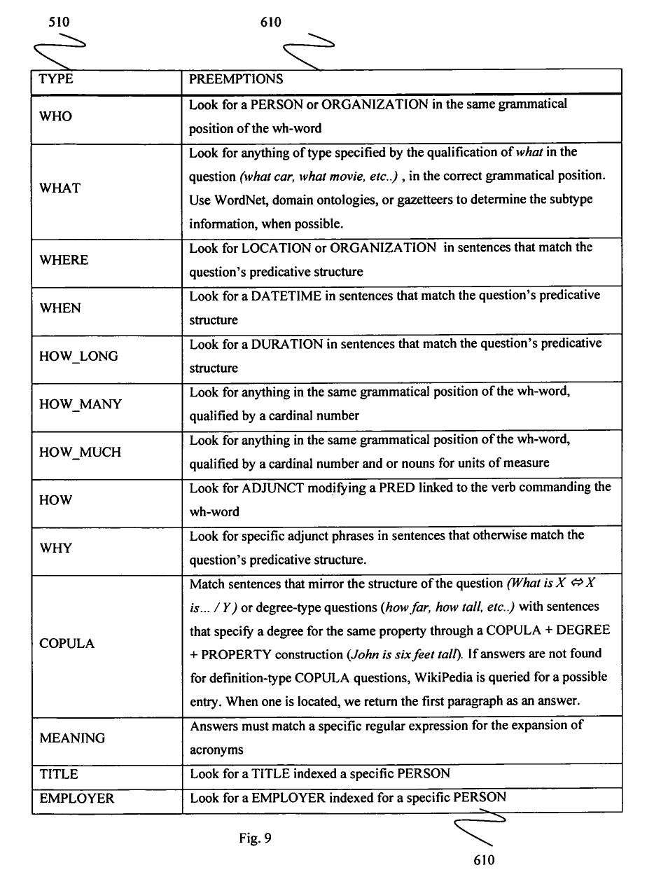

FIG. 9 shows how the matching process differs for different types of questions.

Each of the circuits 5-60 of the structural natural language index system 100 described in FIG. 3 can be implemented as portions of a suitably programmed general-purpose computer. Alternatively, circuits 5-60 of the structural natural language index system 100 outlined above can be implemented as physically distinct hardware circuits within an ASIC, or using a FPGA, a PDL, a PLA or a PAL, or using discrete logic elements or discrete circuit elements. The particular form each of the circuits 5-60 of the structural natural language index system 100 outlined above will take is a design choice and will be obvious and predicable to those skilled in the art.

Moreover, the structural natural language index system 100 and/or each of the various circuits discussed above can each be implemented as software routines, managers or objects executing on a programmed general purpose computer, a special purpose computer, a microprocessor or the like. In this case, the structural natural language index system 100 and/or each of the various circuits discussed above can each be implemented as one or more routines embedded in the communications network, as a resource residing on a server, or the like. The structural natural language index system 100 and the various circuits discussed above can also be implemented by physically incorporating the structural natural language index system 100 into software and/or a hardware system, such as the hardware and software systems of a web server or a client device.

As shown in FIG. 3, memory store 20 and structural natural language index storage structure 25 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like. Moreover, in various exemplary embodiments according to this invention, memory store 20 and structural natural language index storage structure 25 may be implemented as a document or information repository and/or any other system for storing and/or organizing documents. The memory store 20 and structural natural language index storage structure 25 may be embedded or accessed over communications links.

The communication links 99 shown in FIGS. 1 & 3 can each be any known or later developed device or system for connecting a communication device to structural natural language index system 100, including a direct cable connection, a connection over a wide area network or a local area network, a connection over an intranet, a connection over the Internet, or a connection over any other distributed processing network or system. In general, the communication links 99 can be any known or later developed connection system or structure usable to connect devices and facilitate communication.

Further, it should be appreciated that the communication links 99 can be wired or wireless links to a network. The network can be a local area network, a wide area network, an intranet, the Internet, or any other distributed processing and storage network.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A system for indexing natural language text comprising:
an input/output circuit that retrieves a text;
a linearization rule storage structure that stores linearization rules;
a processor that segments the retrieved text into text portions;
a constituent structure circuit that determines the constituent structure of the text portions;
a functional structure circuit for determining the functional structure of the text portions;
a characterizing predicative triples circuit that applies linearization transfer rules from the linearization transfer rule storage structure to the functional structure to determine characterizing predicative triples;
a derived feature extraction circuit for extracting at least one of: named entity, co-reference, lexical entry, semantic-structural relationship, attribution and meronymic information from the text portions;
an index circuit that creates canonized representations of the text portions based on the constituent structures, the characterizing predicative triples and the derived features and stores them in the structural natural language index storage structure.

2. The system of claim 1, in which the processor segments the text into sentences.

3. The system of claim 1, in which the functional structure is determined using the Xerox Linguistic Environment.

4. The system of 3, in which the linearization transfer rules perform at least one of: canonize passivization, canonize ditransitive constructions, and discard redundant information, from the functional structure.

5. The system of claim 1, in which lexical entry variations in the canonized form include: all word senses, all synonyms for each word sense, all hypernyms in a set of given ontologies for each word sense, the first level hyponyms for each word sense.

6. The system of claim 5, wherein the information is extracted from a WordNet ontology.

7. A system for creating a question template for searching a structural natural language index, comprising:
an input/output circuit that retrieves a question;
a question classification circuit that classifies the question into a question type;
a linearization rule storage structure that stores linearization rules;
a constituent structure circuit that determines the constituent structure of the question;
a functional structure circuit for determining the functional structure of the question;
a characterizing predicative triples circuit that applies linearization transfer rules from the linearization transfer rule storage structure to the functional structure to determine characterizing predicative triples;
a derived feature extraction circuit for extracting at least one of: named entity, co-reference, lexical entry, semantic-structural relationship, attribution and meronymic information from the question;
an index circuit that creates a canonical representation of the question based on the constituent structures, the characterizing predicative triples and the derived features; and wherein the processor matches the canonical representation of the question against entries in a retrieved structural natural language index storage structure;
a generation circuit that generates an answer based on a generation grammar and at least one of: the characterizing predicative triples and the constituent structure of the matching entry from the structural natural language index storage structure and displays the answer.

8. The system of claim 7, in which the functional structure is determined using the Xerox Linguistic Environment.

9. The system of 8, in which the linearization transfer rules perform at least one of: canonize passivization, canonize ditransitive constructions, and discard redundant information, from the functional structure.

10. A method for indexing natural language text comprising the steps of:
segmenting a text into text portions;
determining a constituent structure for each text portion;
determining a functional structure for each text portion;
determining linearization transfer rules;
determining characterizing predicative triples of each functional structure based on the linearization transfer rules;
extracting derived features including at least one of: named entity, co-reference, lexical entry, semantic-structural relationship, attribution and meronymic information from each text portion;
determining canonized representations for each text portion based on the constituent structures, the characterizing predicative triples and the derived features; and
determining a structural index based on the canonized representation of the text portion.

11. The method of claim 10, in which the text is segmented into sentences.

12. The method of claim 10, in which the functional structure is determined using the Xerox Linguistic Environment.

13. The method of 12, in which the linearization transfer rules perform at least one of: canonize passivization, canonize ditransitive constructions, and discard redundant information, from the functional structure.

14. The method of claim 11, in which lexical entry variations in the canonized form include: all word senses, all synonyms for each word sense, all hypernyms in a set of given ontologies for each word sense, the first level hyponyms for each word sense.

15. The method of claim 14, where the information is extracted from WordNet ontology.

16. A method of creating a question template for searching a structural natural language index, comprising the steps of:
determining a constituent structure for the question;
determining a functional structure for the question;
determining linearization transfer rules;
determining characterizing predicative triples of each functional structure based on the linearization transfer rules;
extracting derived features including at least one of: named entity, co-reference, lexical entry, semantic-structural relationship, attribution and meronymic information from the question;
determining a canonized representation of the question based on the constituent structures, the determined predicative triples and the derived features; and
searching the structural index of canonized forms for canonized forms based on the canonized representation of the question and the question type;
generating an answer based on a generation grammar and at least one of the characterizing predicative triples and the constituent structure of any matching entries.

17. The method of claim 16, in which the functional structure is determined using the Xerox Linguistic Environment.

18. The method of 17, in which the linearization transfer rules perform at least one of: canonize passivization, canonize ditransitive constructions, and discard redundant information, from the functional structure.

19. Computer readable storage medium comprising: computer readable program code embodied on the computer readable medium, the computer readable program code usable to program a computer for structural indexing of natural language text comprising the steps of:
segmenting a text into text portions;
determining a constituent structure for each text portion;
determining a functional structure for each text portion;
determining linearization transfer rules;
determining characterizing predicative triples of each functional structure based on the linearization transfer rules;
extracting derived features including at least one of: named entity, co-reference, lexical entry, semantic-structural relationship, attribution and meronymic information from each text portion;
determining canonized representations for each text portion based on the constituent structures, the characterizing predicative triples and the derived features; and
determining a structural index based on the canonized representation of the text portion.

20. Computer readable storage medium comprising: computer readable program code embodied on the computer readable medium, the computer readable program code usable to program a computer for searching a structural indexing of natural language text comprising the steps of:
determining a constituent structure for the question;
determining a functional structure for the question;
determining linearization transfer rules;
determining characterizing predicative triples of each functional structure based on the linearization transfer rules;
extracting derived features including at least one of: named entity, co-reference, lexical entry, semantic-structural relationship, attribution and meronymic information from the question;
determining a canonized representation of the question based on the constituent structures, the determined predicative triples and the derived features; and
searching the structural index of canonized forms for canonized forms based on the canonized representation of the question and the question type;
generating an answer based on a generation grammar and at least one of the characterizing predicative triples and the constituent structure of any matching entries.
